(19) United States
(12) Patent Application Publication
(10) Pub. No.: US 2004/0213895 A1
(43) Pub. Date: Oct. 28, 2004

(54) Method of manufacturing multilevel interconnection

(75) Inventors: Shoso Shingubara, Higashi-Hiroshima-shi (JP); Takayuki Takahagi, Aki-gun (JP); Zenglin Wang, Higashi-Hiroshima-shi (JP)

Correspondence Address: NIXON & VANDERHYE, PC, 1100 N GLEBE ROAD, 8TH FLOOR, ARLINGTON, VA, 22201-4714, US

(73) Assignee: Semiconductor Technology Academic Research Center, Yokohama-shi (JP)

(21) Appl. No.: 10/809,681

(22) Filed: Mar. 26, 2004

(30) Foreign Application Priority Data
Apr. 24, 2003 (JP) 2003-120338

(51) Int. Cl. B05D 5/12

(52) U.S. Cl. 427/58; 427/569; 205/183

(57) ABSTRACT

A method of manufacturing an embedded multilevel interconnection, comprising the steps of: forming a hole portion in an insulating layer; forming a barrier metal film mainly made of tantalum and nitrogen in such a manner that the barrier metal film covers at least an inner wall of the hole portion, an element composition ratio (N/Ta) of nitrogen to tantalum contained in the barrier metal film being 0.3 or higher but 1.5 or lower; removing an oxide film formed on a surface of the barrier metal film; and immersing the barrier metal film in a plating liquid comprising copper and thereby forming an electroless copper plating film on the barrier metal film.

### CROSS-REFERENCE TO RELATED APPLICATION

Related patent application is commonly assigned Japanese Patent Application No. 2003-120338 filed on Apr. 24, 2003, which is incorporated by reference into the present patent application.

### BACKGROUND OF THE INVENTION

1. Field of the Invention

The present invention relates to a method of manufacturing a multilevel interconnection, and more particularly, to a method of manufacturing an embedded multilevel interconnection.

2. Description of the Related Art

As a device scale has become smaller and the aspect ratio of a via hole in which a wire is buried has accordingly increased, development of a void within the via hole has arisen as a problem with a method of manufacturing an embedded multilevel interconnection which uses a conventional damascene process.

To deal with this, a displacement plating method has been proposed according to which copper plating is provided without using a catalyst such as Pd on a TaN barrier layer formed inside a via hole (Zenglin Wang, Hiroyuki Sakaue, Shoso Shingubara and Takayuki Takahagi “Electroless Plating of Cu Initiated by Displacement Reaction on Metal-Nitride Diffusion Barriers” Electrochem. Solid-State Letters, 6 (3) (2003) C38-C41).

A displacement plating method utilizes that in a plating solution, when the oxidation-reduction potential of underlying metal is lower than the oxidation-reduction potential of copper which is contained in the plating solution, ions of the underlying metal are oxidized and accordingly dissolve in the plating solution, and instead, copper ions within the plating solution are reduced and deposited.

In the event that TaN is used as underlying metal (barrier metal) of a multilevel interconnection, mere immersion of the underlying metal in an electroless copper plating liquid causes plating of copper by means of displacement. Further, since autocatalytic plating is possible after deposition of copper, it is possible to deposit an electroless copper plating film on the underlying metal through simple steps.

FIGS. 3A-3E show cross sectional views of conventional steps of manufacturing a multilevel interconnection using a displacement plating method. These manufacturing steps include the following steps 1 through 5.

Step 1: As shown in FIG. 3A, an inter-layer insulating film 3 of silicon oxide is formed on an inter-layer insulating film 1 which is made of silicon oxide and has a lower-layer wire 2. Next, the inter-layer insulating film 3 is etched, thereby forming a via hole (hole portion) 4. Further, through sputtering, a barrier metal film (underlying metal) 15 of TaN is formed on the entire surface.

Step 2: As shown in FIG. 3B, the barrier metal film 15 is exposed to atmosphere, whereby a surface of the barrier metal film 15 is-oxidized and a native oxide film 16 of TaN is formed.

Step 3: As shown in FIG. 3C, the native oxide film 16 formed on the surface of the barrier metal film 15 is removed through etching.

Step 4: As shown in FIG. 3D, by immersing into a plating liquid which contains copper, an electroless copper plating film 17 is formed by a displacement plating method.

Step 5: As shown in FIG. 3E, further, by an electrolytic plating method, an electrolytic copper plating film 18 is formed. Through these steps, a multilevel interconnection 200 is completed.

However, even when a displacement plating method is used, there arises a problem of a void within a via hole as a device scale becomes smaller and the line width of a wire becomes as narrow as 100 nm or less for instance. Noting this, the inventors of the present invention studied the causes of a void and learned the following.

That is, as a device scale becomes smaller, the film thickness of the barrier metal film 15 decreases. Because of this, at the above-mentioned step 2, the barrier metal film 15 located on a side wall where the film thickness is thinner than that on a bottom surface turns entirely into the native oxide film 16. Therefore, through removal of the native oxide film 16 at the step 3, no barrier metal film 15 will remain on the side wall.

As a result, any plating film is not formed on a side wall of the via hole 4 at the step 4 which is an electroless plating step, which in turn will causes a void 19.

According to the ITRS semiconductor roadmap for example, the film thickness of a barrier metal film will be 8 nm for the 65 nm line-width generation and will be 5 nm for the 45 nm line-width generation. Hence, if the film thickness of the native oxide film (oxygen-rich layer) 16 formed on the surface of the barrier metal film 15 of TaN exceeds 5 nm, a void will be created. In the event that the barrier metal film 15 is formed by a sputtering method in particular, the film thickness of the barrier metal film 15 located on the side wall of the via hole is thin, and therefore, development of a void will be remarkable.

### SUMMARY OF THE INVENTION

An object of the present invention is to provide a method of manufacturing a multilevel interconnection for an LSI having fine wires, according to which a native oxide film formed on a surface of a barrier metal film is thin and development of a void is prevented.

The present invention is directed to a method of manufacturing an embedded multilevel interconnection, comprising: a step of forming a hole portion in an insulating layer; a barrier metal film forming step of forming a barrier metal film mainly made of tantalum and nitrogen in such a manner that the barrier metal film covers at least an inner wall of the hole portion, an element composition ratio (N/Ta) of nitrogen to tantalum contained in the barrier metal film being 0.3 or higher but 1.5 or lower; a removal step of removing an oxide film formed on a surface of the barrier metal film; and an electroless plating step of immersing the barrier metal film in a plating liquid comprising copper and thereby forming an electroless copper plating film on the barrier metal film.

Use of the barrier metal film having such an element composition ratio allows that the film thickness of the native oxide film formed on the barrier metal film is as thin as 1 nm or less, for instance. In addition, a favorable value of resistance as a wiring layer is obtained.

The element composition ratio (N/Ta) is preferably 0.3 or higher but 1.0 or lower.

The barrier metal film forming step may be a plasma nitriding step at which nitrogen plasma is irradiated upon a surface of a film which is comprised mainly of tantalum and accordingly nitriding tantalum.

The removal step is such a step at which the oxide film is removed and the barrier metal film is left in such manner that the barrier metal film entirely covers the inner wall of the hole portion. As the barrier metal film is left on the entire surface, it is possible to prevent development of a void at the plating step.

The removal step is preferably such a step at which the barrier metal film is immersed in a mixture of a hydrofluoric acid and a nitric acid or a diluent of a hydrofluoric acid and the oxide film is selectively removed.

The electroless plating step is preferably such a step at which the barrier metal film is immersed in a plating liquid which uses a glyoxylic acid as a reducer.

The present invention may further contain a step of plating an electrolytic copper plating film on the electroless copper plating film by using the electroless copper plating film as a seed layer.

As clearly described above, by using the method of manufacturing a multilevel interconnection according to the present invention, growth of a native oxide film on a surface of a barrier metal film is suppressed. This makes it possible to form a buried interconnection in which development of a void is discouraged.

### BRIEF DESCRIPTION OF THE DRAWINGS

FIGS. 1A-1E shows cross sectional views of the steps of manufacturing a multilevel interconnection according to the embodiment 1 of the present invention;

FIG. 2 shows a relationship between the time during which a barrier metal film is left in atmosphere and the film thickness of a native oxide film (TaOx) formed on the surface of the barrier metal film in a condition that the element composition ratio (N/Ta) of the barrier metal film is changed; and

FIGS. 3A-3E shows cross sectional views of the conventional steps of manufacturing a multilevel interconnection.

### DETAILED DESCRIPTION OF THE PREFERRED EMBODIMENTS

### Embodiment 1

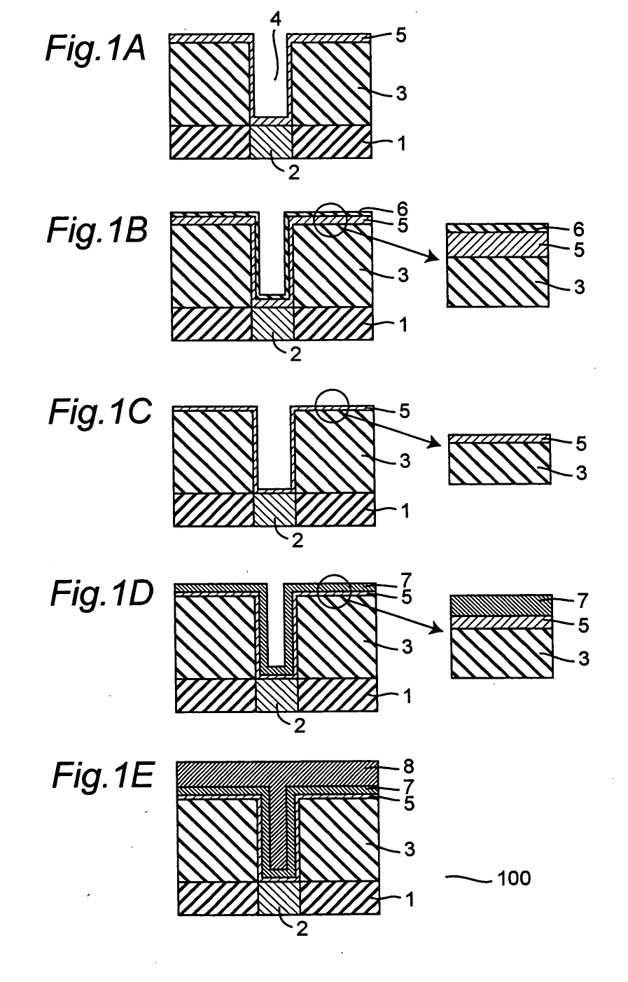

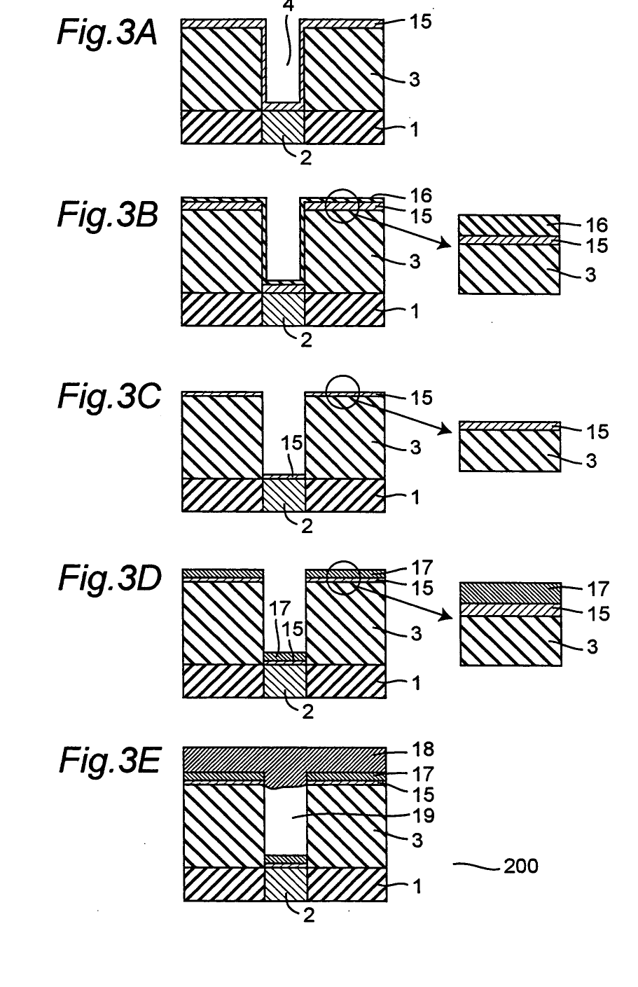

FIG. 1 shows cross sectional views of steps of manufacturing a multilevel interconnection according to an embodiment 1. In FIG. 1, the same reference symbols to those shown in FIG. 3 denote the same or corresponding portions. These manufacturing steps include the following steps 1 through 5.

Step 1: As shown in FIG. 1A, an inter-layer insulating film 3 of silicon oxide is formed on an inter-layer insulating film 1 which is made of silicon oxide and has a lower-layer wire 2. Next, the inter-layer insulating film 3 is etched, thereby forming a via hole (hole portion) 4.

Following this, by a sputtering method, a barrier metal film (underlying metal) 5 of TaN is formed on the entire surface. As a sputtering gas, a mixture gas of Ar and N₂ is used, for example. Sputtering conditions such as a nitrogen partial pressure are adjusted so that the element composition ratio (N/Ta) of the barrier metal film 5 will be controlled to be 0.3 or higher but 1.5 or lower, and more preferably, 0.3 or higher but 1.0 or lower. When the barrier metal film 5 is formed by sputtering in this manner, the film thickness on a side wall becomes thinner than that on a bottom portion of the via hole 4. When the film thickness on the bottom portion is about 10 nm, the film thickness on the side wall is about 2 nm, for example.

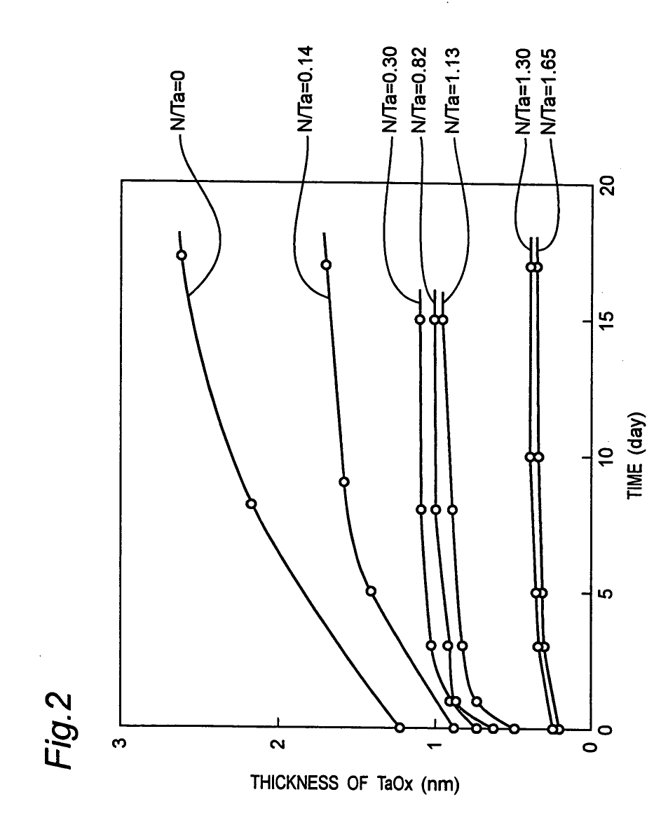

FIG. 2 shows a relationship between the time during which the barrier metal film 5 is left in atmosphere and the film thickness of the native oxide film (TaOx) 6 formed on the surface of the barrier metal film in a condition that the element composition ratio (N/Ta) of the barrier metal film 5 of TaN is changed from 0 to 1.65.

As can be seen in FIG. 2, when N/Ta is 0.30, exposure to atmosphere for 15 days makes the native oxide film 6 grow into the film thickness of merely about 1 nm. During actual manufacturing steps, the barrier metal film 5 is exposed to atmosphere only for a few minutes, and hence, use of the barrier metal film 5 whose element composition ratio is such allows to control the film thickness of the native oxide film 6 to 1 nm or less.

When the element composition ratio (N/Ta) of the barrier metal film 5 is larger than 1.5, the resistivity of TaN becomes extremely high. Hence, TaN preferably has an element composition ratio (N/Ta) of 1.5 or smaller, and more preferably, 1.0 or smaller, to be used as a material of wires.

In addition, although the barrier metal film 5 of TaN is formed by a sputtering method, the barrier metal film 5 of TaN may be formed by an ALD (Atomic Layer Deposition) method, a CVD method or the like.

Step 2: As shown in FIG. 1B, the barrier metal film 5 is exposed to atmosphere, whereby the surface of the barrier metal film 5 is oxidized and the native oxide film 6 of TaN is formed. At this stage, the element composition ratio (N/Ta) of the barrier metal film 5 is controlled to be 0.3 or higher but 1.5 or lower. Hereby, the film thickness of the native oxide film 6 formed by oxidation of the barrier metal film 5 is about 1 nm or thinner.

As described above, since the film thickness of the barrier metal film 5 located on the side wall of the via hole 4 is about 2 nm, even when the native oxide film 6 as thick as about 1 nm is formed, the barrier metal film 5 which is not oxidized remains in the film thickness of about 1 nm on the side wall of the via hole 4.

Step 3: As shown in FIG. 1C, the native oxide film 6 formed on the surface of the barrier metal film 5 is removed by etching. The etching uses a mixture of a hydrofluoric acid and a nitric acid or a diluent which is prepared by diluting a hydrofluoric acid with pure water ten or more times. This makes it possible to selectively remove the native oxide film 6 without damaging the barrier metal film 5.

Concretely, an aqueous solution mixed at a ratio of HF:HNO₃:H₂O=1:1:30 is used as an etchant. The etchant is set to a temperature of about 25° C., and the etching time is about three minutes. As shown in FIG. 1C, this etching step leaves the barrier metal film 5 from whose surface the native oxide film 6 has been removed, on the bottom portion and the side wall of the via hole 4 and a top surface of the inter-layer insulating film 3.

Step 4: As shown in FIG. 1D, by means of immersion into a plating liquid which contains copper, electroless plating is executed. The plating liquid is mainly made of copper sulfate, a glyoxylic acid (reducer), ethylene diaminetetraacetate (complexing agent) and bipyldin (stabilizer). Plating conditions are, for instance, that pH of the solution is 12 and the temperature of the solution is 70° C.

Through such electroless plating, a uniform electroless copper plating film 7 as that shown in FIG. 1D is formed which defines a via hole which has the diameter of 100 nm and the aspect ratio (depth/diameter) of about 8. The film thickness of the electroless copper plating film 7 is about 10 nm

The adhesion between the barrier metal film 5 and the electroless copper plating film 7 is tight enough to ensure chemical and mechanical polishing (CMP).

Step 5: As shown in FIG. 1E, by an electrolytic plating method, an electrolytic copper plating film 8 is formed. The electrolytic plating uses a solution which is mainly made of copper sulfate.

Through these steps, a multilevel interconnection 100 is obtained whose via hole 4 is filled up with copper without any void as shown in FIG. 1E.

### Embodiment 2

A method of manufacturing a multilevel interconnection according to the embodiment 2 of the present invention is different as for the step of forming the barrier metal film 5 (step 1) from but is otherwise similar to the manufacturing method according to the embodiment 1 described above.

In other words, the manufacturing method according to the embodiment 2 requires to form a Ta film by a sputtering or CVD method inside a vacuum chamber to eventually form the barrier metal 5 of TaN.

Following this, while maintaining the vacuum chamber at vacuum, nitrogen plasma is irradiated upon a surface of the Ta film, thereby turning an area near the surface of the Ta film into a TaN film. At this nitriding step, nitriding conditions are controlled such that the element composition ratio (N/Ta) of N to Ta within the TaN film will be 0.3 or higher but 1.5 or lower, and more preferably, 0.3 or higher but 1.0 or lower.

Concretely, after introducing nitrogen into the vacuum chamber and setting the vacuum chamber to 10 mTorr, inductively-coupled plasma is generated. A direct current bias of about −50 V is applied upon a substrate which seats a wafer in which a multilevel interconnection is to be formed. Under this condition, an area near the surface of the TaN film is nitrided.

Under this condition, such an TaN film is formed whose element composition ratio (N/Ta) of N to Ta is 0.3 or higher but 1.5 or lower at the depth of about 2 through 4 nm from the surface of the TaN film.

As described in relation to the embodiment 1, even after left in atmosphere for about two weeks, the TaN film having such an element composition ratio grows a native oxide film, which results from oxidation of the surface of the TaN film, into the film thickness of merely 1 nm or less (See FIG. 1B).

As the steps 3 through 5 shown referred to for the embodiment 1 (FIGS. 1C-1E) are carried out after this, the multilevel interconnection 100 is obtained.

Although the foregoing has described the embodiments 1 and 2 as an example where TaN is used as the material of the barrier metal film 5, other TaN-containing material mainly made of Ta and N may be used instead.

What is claimed is:

1. A method of manufacturing an embedded multilevel interconnection, comprising:
a step of forming a hole portion in an insulating layer;
a barrier metal film forming step of forming a barrier metal film mainly made of tantalum and nitrogen in such a manner that the barrier metal film covers at least an inner wall of the hole portion, an element composition ratio (N/Ta) of nitrogen to tantalum contained in the barrier metal film being 0.3 or higher but 1.5 or lower;
a removal step of removing an oxide film formed on a surface of the barrier metal film; and
an electroless plating step of immersing the barrier metal film in a plating liquid comprising copper and thereby forming an electroless copper plating film on the barrier metal film.

2. The method according to claim 1, wherein the element composition ratio (N/Ta) is 0.3 or higher but 1.0 or lower.

3. The method according to claim 1, wherein the barrier metal film forming step is a plasma nitriding step at which nitrogen plasma is irradiated upon a surface of a film which is mainly made of tantalum and accordingly nitriding tantalum.

4. The method according to claim 1, wherein the removal step is such a step at which the oxide film is removed and the barrier metal film is left in such a manner that the barrier metal film entirely covers the inner wall of the hole portion.

5. The method according to claim 1, wherein the removal step is such a step at which the barrier metal film is immersed in a solution selected from the group consisting of a mixture of a hydrofluoric acid and a nitric acid and a diluent of a hydrofluoric acid, and the oxide film is selectively removed.

6. The method according to claim 1, wherein the electroless plating step is such a step at which the barrier metal film is immersed in a plating liquid which uses a glyoxylic acid as a reducer.

7. The method according to claims 1, further comprising a step of forming an electrolytic copper plating film on the electroless copper plating film by using the electroless copper plating film as a seed layer.
